(19) United States
(12) Patent Application Publication
(10) Pub. No.: US 2010/0231025 A1
(43) Pub. Date: Sep. 16, 2010

(54) ADJUSTABLE CRAWLER VEHICLE

(76) Inventor: Michael J. Wagner, Navarre, OH (US)

Correspondence Address: James Ray & Associates, 2640 Pitcairn Road, Monroeville, PA, 15146, US

(21) Appl. No.: 12/599,917

(22) PCT Filed: May 29, 2008
(86) PCT No.: PCT/US08/06776

§ 371 Date: Nov. 12, 2009

Related U.S. Application Data
(60) Provisional application No. 60/932,072, filed on May 29, 2007.

(51) Int. Cl. B62D 55/06; B60K 5/00; B62D 33/063; B60P 1/28; B62D 21/02

(52) U.S. Cl. 298/17 R; 180/298; 180/89.13; 180/9.1; 180/311

(57) ABSTRACT

A work vehicle has an operating cab, a power plant positioned adjacent to the operating cab, a pair of suspension members operable by the power plant and spaced apart in a lateral direction, and a load carrying member supported by the pair of suspension members. The vehicle further has an adjustable undercarriage frame that includes a housing having a predetermined shape and having a longitudinal axis thereof aligned with a longitudinal axis of the vehicle, the housing positioned intermediate the pair of suspension members, whereby each of the pair of suspension members is operatively mounted to a respective side of the housing. The adjustable undercarriage frame also provides for adjusting longitudinal position of the operating cab and the power plant and for adjusting lateral spacing between suspension members. Novel pivot assembly for rotating the load carrying member in order to discharge the load is also provided.

### CROSS-REFERENCE TO RELATED APPLICATIONS

This application is related to and claims priority from Provisional Patent Application Ser. No. 60/932,072 filed on May 29, 2007.

### FIELD OF THE INVENTION

The present invention relates, in general, to carriers and crawlers, and, more particularly, this invention relates to adjustable carrier and crawler vehicles.

### BACKGROUND OF THE INVENTION

As is generally well known in the crawler vehicle prior art, the different bodies, undercarriages, housing widths and track suspensions are advantageous for different applications. Prior to the conception and development of the present invention, efforts have been made to provide variable width (laterally adjustable) track suspensions depending on a specific use of the vehicle. U.S. Pub. No. 2004/0239092 discloses a crawler-tracked vehicle with variable track width wherein at least one of the two chassis carriers can be fastened releasably to a vehicle frame at a different distance transversely to the undercarriage with the aid of carrying members arranged laterally at the front and rear and with the aid of receiving and supporting members and with the aid of holding and releasing assembly. U.S. Pat. No. 5,638,908 issued to Masumoto provides an apparatus for adjusting spacing between a pair of crawler tracks which employs a pair of hydraulic actuating cylinders. U.S. Pat. No. 6,176,334 issued to Lorenzen discloses a combination of using powered actuators for adjusting the spacing between the crawler tracks and affixing each track to the drive wheel shaft. While the prior art device provide for varying width tracks, higher than desirable effort and cost are required to achieve proper spacing.

Furthermore, some operators of crawler vehicles require ease of interchangeability between the undercarriage suspension system and load carrying members or tool implements in order to adapt each crawler vehicle for different uses and to increase its utilization. For example, it is often required to change the undercarriage from a standard configuration to a swamp configuration. It also desirable for crawler vehicles to transport, in a balanced manner, larger loads and safely discharge such larger loads at a point of use. Prior to the conception and development of the present invention, it has been difficult to provide such interchangeability.

Therefore, there is a need for an improved crawler vehicle that can be easily adjusted in both the lateral and longitudinal directions.

### SUMMARY OF THE INVENTION

In accordance with one aspect of the present invention there is provided a work vehicle. The work vehicle has an operating cab. A power plant is positioned adjacent to the operating cab. A pair of suspension members are operable by the power plant and are spaced apart in a lateral direction. A load carrying member is supported by the pair of suspension members. The vehicle also includes an adjustable undercarriage frame. There is means which is provided on the frame for adjusting longitudinal position of at least one of the operating cab and the power plant.

In accordance with another aspect of the present invention there is provided a work vehicle. The work vehicle has an operating cab. A power plant is positioned adjacent to the operating cab. A pair of suspension members are operable by the power plant and are spaced apart in a lateral direction. A load carrying member is supported by the pair of suspension members. The vehicle also includes an adjustable undercarriage frame. The frame includes a housing having a predetermined shape and having a longitudinal axis thereof aligned with a longitudinal axis of the vehicle. The housing is positioned intermediate the pair of suspension members. A pair of spindle shafts are positioned in the lateral direction and spaced apart along the longitudinal axis. Each of the pair of spindle shafts secured to the housing adjacent a respective end thereof. There is means which is engageable with each spindle shaft for adjusting lateral spacing between the pair of suspension members.

In accordance with yet another aspect, the present invention provides a work vehicle. The work vehicle has an operating cab. A power plant is positioned adjacent to the operating cab. A pair of suspension members are operable by the power plant and are spaced apart in a lateral direction. A load carrying member is supported by the pair of suspension members. The vehicle also includes an adjustable undercarriage frame. There is at least one first female connection member which is secured to the undercarriage frame. A first substantially spherical cavity is formed therein. At least one male connection member is provided and has a substantially spherical portion at least partially disposed within the first substantially spherical cavity and a pair of axially aligned and oppositely disposed ends, each of the pair of ends secured to the load carrying member. At least one second female connection member is also provided. A second substantially spherical cavity is formed in the at least one second female connection member. The substantially spherical portion of the male connection member is at least partially disposed within the second substantially spherical cavity. There is means for affixing the at least one second female connection member to the at least one first female connection member and operatively caging the substantially spherical portion of the at least one male connection member between the first and second substantially spherical cavities.

### OBJECTS OF THE INVENTION

It is, therefore, one of the primary objects of the present invention to provide a work vehicle having cab and power plant adjustable in a longitudinal direction.

Another object of the present invention is to provide a work vehicle having a load carrying member adjustable in a longitudinal direction.

Still another object of the present invention is to provide a work vehicle having a pair of rails mounted on its undercarriage frame for enabling adjustments of the cab, power plant and load carrying member in a longitudinal direction.

Yet another object of the present invention is to provide a work vehicle having suspension members adjustable in a lateral direction.

A further object of the present invention is to provide a work vehicle that can be easily converted to heavier duty operation and swamp use.

An additional object is provide a carrier crawler work vehicle that can be adapted for dumping, hauling, drilling and for elevating a boom.

Another object is to provide a carrier crawler work vehicle that permits the load carrying member to rotate on the undercarriage frame.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached figures.

### BRIEF DESCRIPTION OF THE DRAWINGS

FIG. 1 is an elevation side view of an adjustable crawler vehicle of the present invention with a conventional track and dump body;

FIG. 2 is an elevation side view of an adjustable crawler vehicle of the present invention with a conventional track, a dump body and a swing mechanism;

FIG. 3 is an elevation side view of an adjustable crawler vehicle of the present invention with a conventional track and flat bed;

FIG. 4 is an elevation side view of an adjustable crawler vehicle of the present invention with a swamp track and dump body;

FIG. 5 is a cross-sectional elevation view of an undercarriage frame of the adjustable crawler vehicle of the present invention along lines V-V of FIG. 1;

FIG. 6 is a cross-sectional elevation view of an undercarriage frame of the adjustable crawler vehicle of the present invention along lines V-V of FIG. 4;

FIG. 7 is an elevation side view of an adjustable crawler vehicle with long load in carrying and discharge positions, where the cab is mounted in a conventional position;

FIG. 8 is an elevation side view of an adjustable crawler vehicle with long load in carrying and discharge positions where the cab is adjusted forward;

FIG. 9 is an elevation side view of an adjustable crawler vehicle with long load in carrying and discharge positions where the cab is adjusted forward and the bed pivot axis is adjusted rearward;

FIG. 10 is a side elevation view of a pivot member employed on adjustable crawler vehicles of FIGS. 1-4;

FIG. 11 is a cross-sectional elevation view of the undercarriage frame along lines XI-XI of FIG. 10; and

FIG. 12 is an elevation side view of an adjustable crawler vehicle of the present invention with a track and a crane-type tool implement.

### BRIEF DESCRIPTION OF A PRESENTLY PREFERRED AND VARIOUS ALTERNATIVE EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

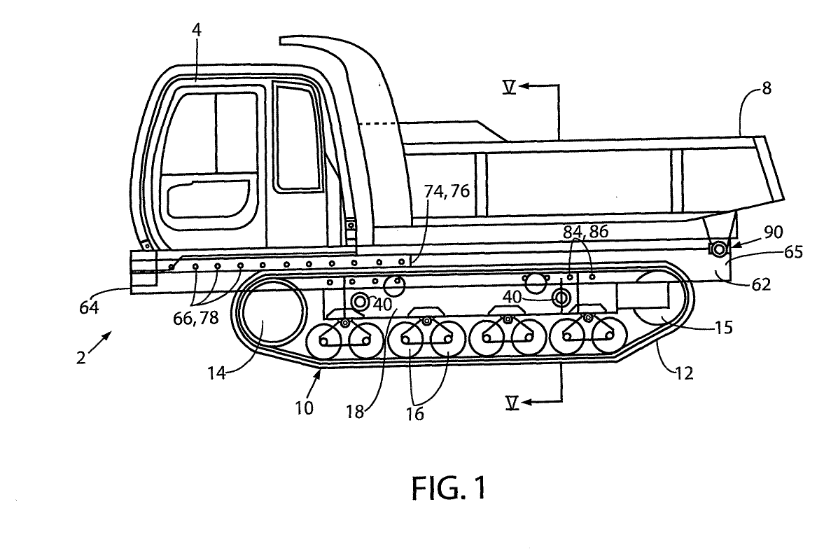

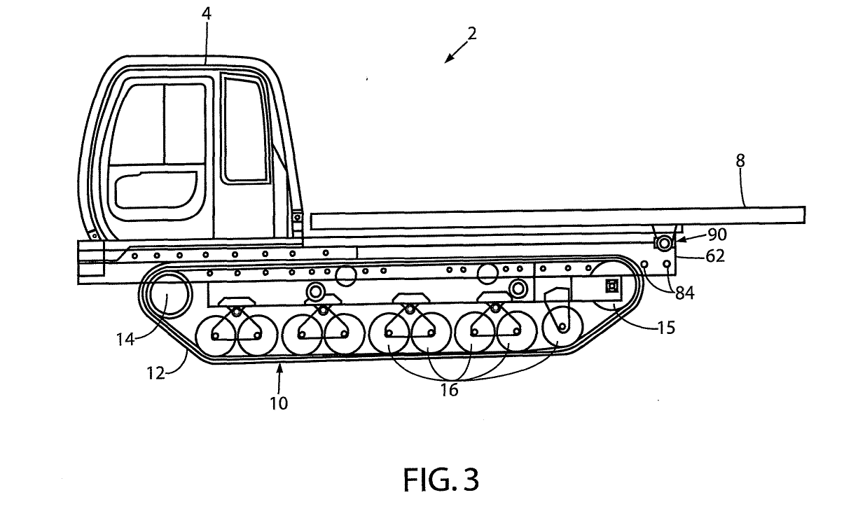

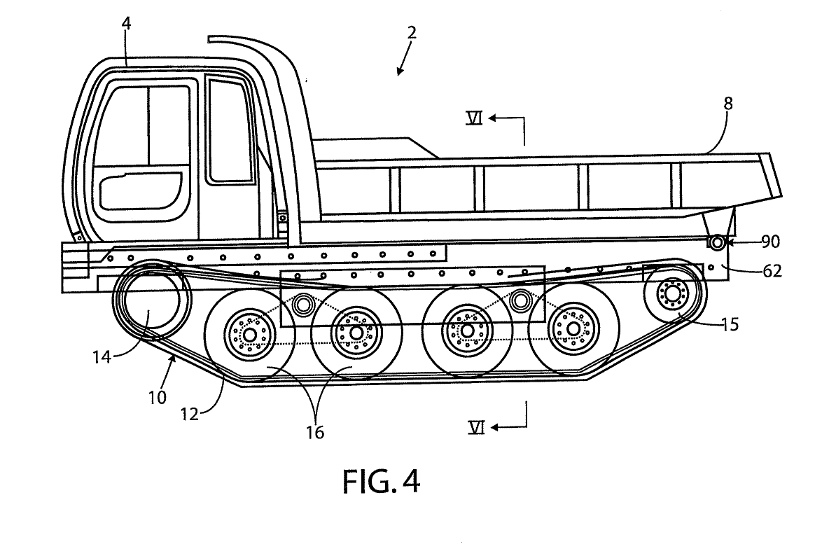

Reference is now made, more particularly, to FIGS. 1-4 that show various forms of the crawler or carrier work vehicle, generally designated as 2, of the present invention. As is conventional in the art, the crawler vehicle 2 includes a cab 4 and a power plant 6, both positioned at the front of the crawler vehicle 2 and generally aligned with a respective side thereof. In the present invention the definition of the power plant includes conventional driving force apparatus, heat exchanger, oil tank, fuel tank and the like devices. Any conventional power plant 6 may be employed in the vehicle 2 of the present invention. For example, such power plant may be of the type disclosed in U.S. Pat. No. 6,523,905 issued to Tamura et al. and whose teachings are incorporated into this document by reference thereto. A load carrying member 8 is mounted rearward of the cab 4 and power plant 6. The load carrying member 8 is illustrated as a conventional dump body in FIGS. 1-2 and 4 and as a conventional flat or platform bed in FIG. 3. Pair of laterally spaced apart ground engaging suspension members 10 are operatively coupled to the power plant 6 and are provided for supporting the load carrying member 8 and for enabling movement of the crawler vehicle 2. As is conventional, each suspension member 10 includes an endless track 12, a driving wheel 14, an idler wheel 15 and a plurality of load support wheels or rollers 16, all mounted on the track frame 18 and operatively meshing with such endless track 12. In a regular-type suspension member 10 of FIGS. 1-3 the wheels 16 are mounted in a tandem arrangement at the bottom of the track frame 18, while in a swamp-type suspension member 10 of FIG. 4 the wheels 16 extend the entire height of the track 12.

Any conventional suspension member may be employed in the vehicle 2 of the present invention, although is has been found advantageous to adapt the regular-type suspension member 10 with odd quantity of wheels 16, as best shown in FIG. 3 and position a single wheel 16 at the rear end of the suspension member 10. Such single wheel 16 improves reaction forces of the suspension member 10 when the vehicle 2 operates on a grade.

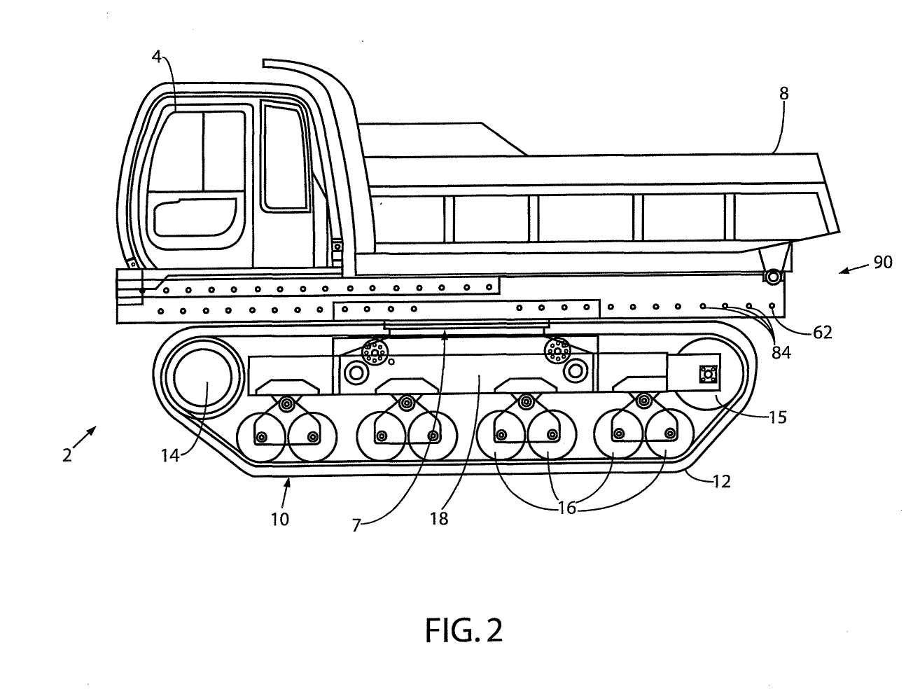

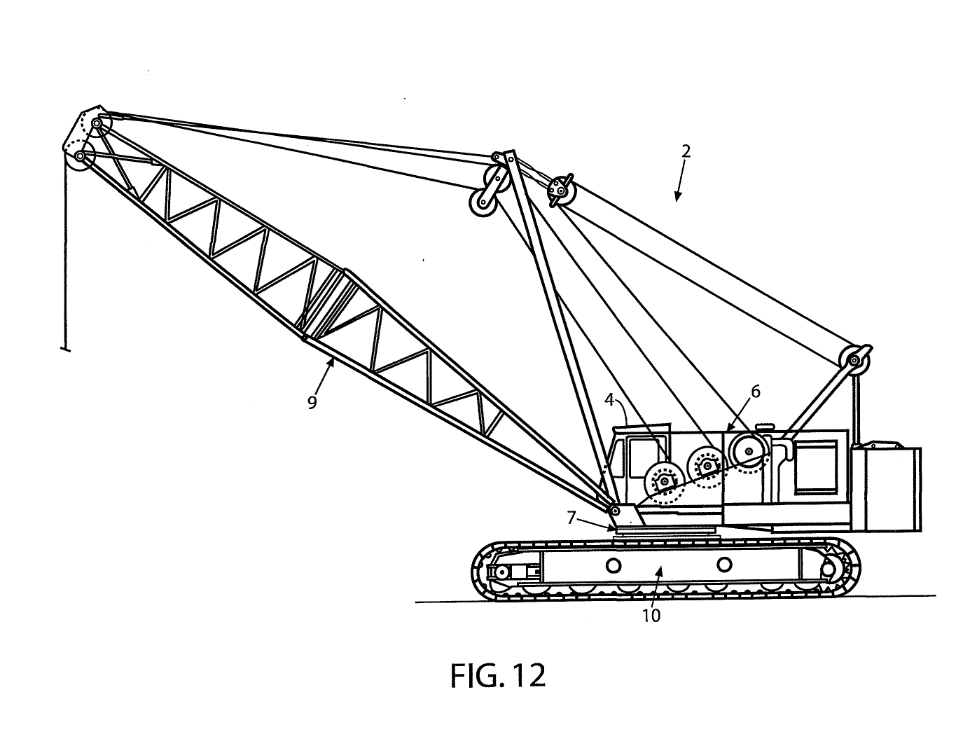

Now in reference to FIG. 12, the work vehicle 2 is illustrated as having a tool implement 9 of a crane type, although other conventional tool implements are contemplated within the present invention. In further reference to FIGS. 2 and 12, such work vehicle 2 is shown as having a conventional swing mechanism 7 which is well known in the art and whose detail description is omitted in this document for the sake of brevity.

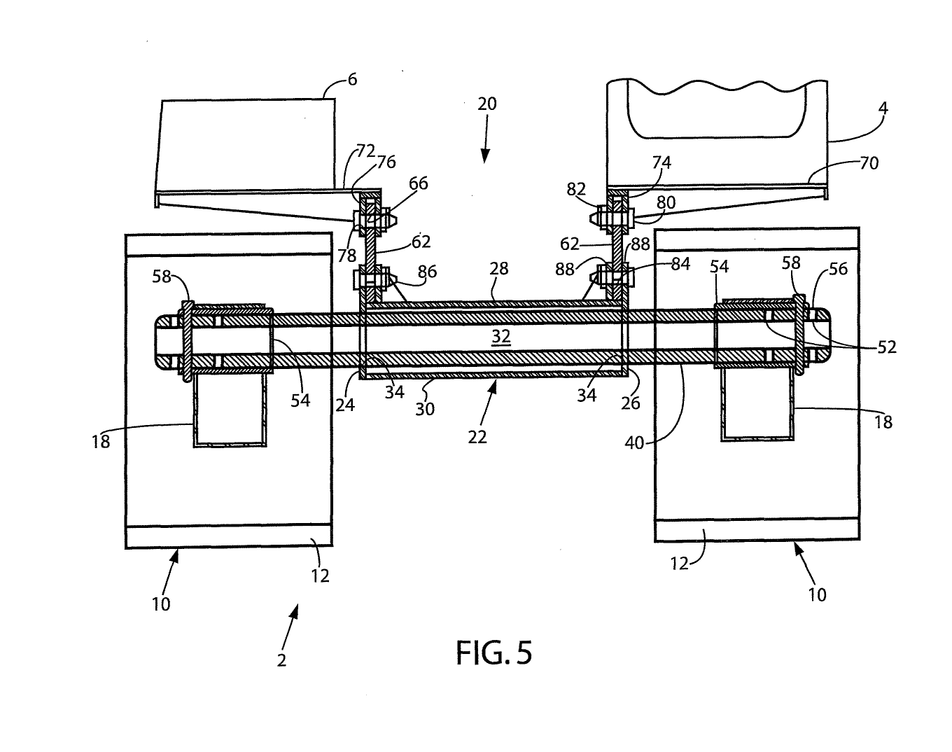

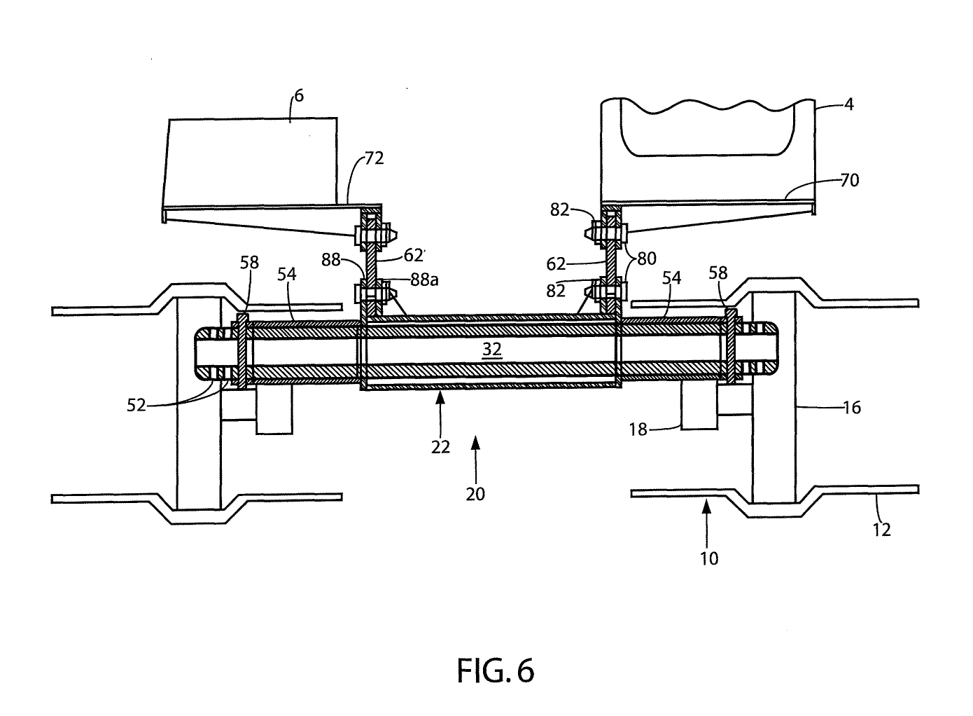

The vehicle 2 also includes a novel undercarriage frame, generally designated as 20, that provides for adjustments of the cab 4, power plant 6 and load carrying member 8 or tool implement 9 in a longitudinal direction and for adjustments of the suspension members 10 in the lateral direction. The structure of the undercarriage frame 20 is best shown in FIGS. 5-6.

In accordance with one embodiment of the invention for providing lateral adjustments of the suspension members 10, the undercarriage frame 20 includes a housing 22, which is preferably constructed as a hollow member for weight reduction purposes. Thus, the housing 22 is provided with a first longitudinal side wall member 24, an opposed second longitudinal side wall member 26, a top member 28 and a bottom member 30. Preferably, each of the above-referenced members is a plate-like member manufactured from a steel material and rigidly secured to one another, for example by a welding method, to form, in combination, a hollow interior portion 32. Equally as well, the housing 20 may be formed as a single-piece member by a casting or forging process. It will be appreciated that the housing 22 is positioned intermediate such pair of suspension members 10, whereby each of such pair of suspension members 10 is operatively mounted to a respective side of the housing 22 and wherein such cab 4 and such power plant 6 are generally positioned forward of the housing 22.

A pair of spaced apart spindle shafts 40 are also provided with each spindle shaft 40 secured to the housing 22 adjacent a respective end thereof and transversely to the longitudinal axis of the vehicle 2. Preferably, each spindle shaft 40 is inserted through the housing 22. Accordingly, the housing 22 further includes a first pair of spaced-apart apertures 34 formed through the first side wall member 24 and a second pair of spaced-apart apertures 34 formed through the second side wall member 26 in respective alignment with the first pair of apertures 34. Thus, each spindle shaft is simply passed through a respective pair of apertures 34 aligned in the lateral direction relative to the longitudinal axis of the vehicle 2 and is secured to the housing 22, for example by a welding method, to increase strength and load carrying ability thereof. The spindle shaft 40 may be of a solid cross-section and, preferably, of a hollow cross-section as best shown in FIGS. 5-6 for weight reduction purposes. Thus, a cylindrical tubular spindle shaft 40 will be employed in a present invention.

There is also a plurality of means each engageable with a respective end of the spindle shaft 40 for adjusting lateral spacing between such pair of suspension members 10. In accordance with a presently preferred embodiment of the invention, such lateral spacing adjusting means includes a predetermined plurality of first apertures 52 formed in a spaced relationship through each end of the each spindle shaft 40. A hollow bushing or sleeve 54 is slideably mounted at the each end of the spindle shaft 40 and is secured, to a respective track frame 18 of the respective suspension member 10. A second aperture 56 is formed through the sleeve 54 and is aligned with a selected one of the predetermined plurality of first apertures 52 based on a pre-selected spacing between such pair of suspension members 10. A pin 58 is passed through the second aperture 56 and the selected first aperture 52 for fixing the spacing of such pair of suspension members 10. Such arrangement enables ease of adjusting spacing between suspension members 10 without detaching each suspension member 10 from the undercarriage frame 20. Furthermore, each suspension member 10 can be independently adjusted. The width of the housing 22 is predetermined based on the width of the endless track 12 to enable inward adjustment of the suspension members 10 so that the overall width of the vehicle 2 is smaller than the width of the shipping container or the truck bed which is presently set at about seven and a half feet. Thus, the vehicle 2, with its suspension members 10 being adjusted inwardly, can be easily transported by way of a rail container (not shown). The work vehicle 2 can be also transported by over-the-road truck without the need for wide-load permits and increased transportation costs associated therewith.

In accordance with another embodiment of the invention the vehicle 2 includes means for providing adjustments of the cab 4, power plant 6 and load carrying, member 8 in a longitudinal direction. Such longitudinal adjustments means includes a pair of elongated members 62 disposed in a spaced-apart relationship to each other and parallel to the longitudinal axis of the vehicle 2 for supporting such cab 4, power plant 6 and such at least one of powered working tool 9 and load carrying member 8. It will be understood that the elongated members 62 are attached to the top surface of the undercarriage frame 20. The undercarriage frame 20 in this embodiment may be of any well known constructions and may include the above-described housing 22. Furthermore, each elongated member 62 is shown in FIGS. 5-6 as a plate-like member disposed in a vertical direction, although other shapes, for example such as U-shape, Z-shape beams and hollow tubular members may be employed in the present invention. At least a portion of each elongated member 62 which is disposed in a vertical direction toward a front end 64 thereof is provided with first apertures 66 which are spaced-apart in the longitudinal direction and which have axis thereof aligned in the lateral direction. A pair of support members 70 and 72 are also provided for respectively supporting the cab 4 and the power plant 6, although a single support member is also contemplated by the present invention. Each support member 70, 72 further has a respective plate-like flange 74, 76 disposed in a vertical direction in abutting engagement with a respective elongated member 62 and adapted with plurality of second apertures 78 which are spaced-apart in the longitudinal direction and which have axis thereof aligned in the transverse direction. The spacing between a pair of the second apertures 78 is identical to the spacing between the pair of first apertures 66. In operation, after the longitudinal position of the support members 70 and 72 is determined based on a particular configuration of the vehicle 2, at least a portion of the second apertures 78 are aligned with at least a portion of the first apertures 66 and fasteners 80, 82 preferably of a threaded type are employed to fix such longitudinal position. The load carrying member 8 is then positioned rearward of the cab 4 and the power plant 6 and attached to the elongated members 62 in a conventional manner. Thus, the present invention provides for simple and cost effective method of adjusting longitudinal position of the cab 4 and the power plant 6 relative to the undercarriage frame 20 and relative to the suspension members 10 and, more specifically, provides for use of load carrying member 8 having different lengths.

The longitudinal adjustment means may further provide for adjusting the elongated members 62 relative to the undercarriage frame 20. To achieve this adjustment, the portion of the elongated member 62 which is disposed in a vertical direction toward a rear end 65 thereof is provided with third apertures 84 which are spaced-apart in the longitudinal direction and which have axis thereof aligned in the lateral direction. A plurality of mating spaced-apart fourth apertures 86 are then provided in the undercarriage frame 20. When the undercarriage frame 20 employs the above-described housing 22, such housing 22 may be adapted with at least one vertical flange 88 secured to a top surface thereof. The spaced-apart fourth apertures 86 are then formed through, the flange 88. The flange 88 may be a simple plate-like member, best shown in FIGS. 5-6, either integrally formed with the housing 22 or securely affixed thereto, for example by a welding method. In use, the selected third and fourth apertures 84, 86 respectively, are aligned therebetween and the elongated member 62 is affixed to the flange 88 with fasteners, for example such as threaded fasteners 82, 84.

If required for the sake of rigidity, a second support flange 88a may be also provided and affixed to the frame 20 in spaced parallel relationship to the first flange 88 for caging an edge portion of the elongated member 62 therebetween. The second support flange 88a is then also provided with the plurality of forth apertures 86 with the fasteners passing through a pair of traversly aligned apertures 86. It is also within the scope of the present invention to provide the flanges 88, 88a as a one-piece U-shaped member.

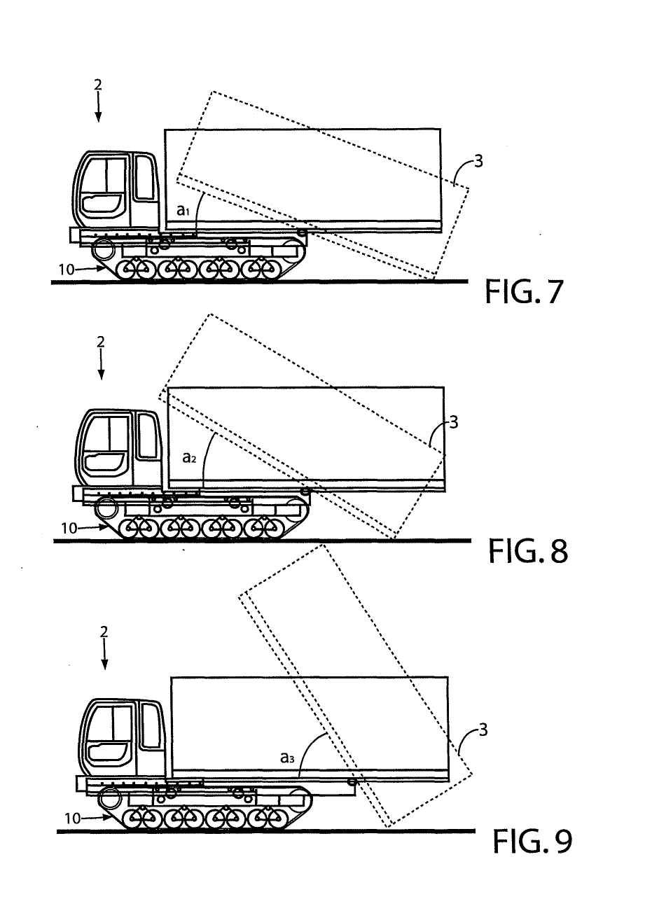

The criticality of independently adjusting the elongated members 62 and the cab 4 and power plant 6 relative to the undercarriage frame 20 is best illustrated on the examples of FIGS. 7-9. It must be noted that the load carrying member 8 is pivotally connected, in a conventional manner, to the elongated members 62 by way of a pair of pivot joint assemblies 90. Thus, the load carrying member 8 is pivoted in a vertical plane and in a clock-wise direction in FIGS. 7-9 for discharging the load 3. It has been found that on the prior art crawler vehicles 2 configured with a longer load carrying member 8 extending beyond the rear end of the suspension member 10 at a distance greater than the height thereof and wherein the pair of pivot joint assemblies 90 are generally aligned with the rear end of the suspension member 10, as shown in FIG. 7, the maximum pivot angle a₁ is insufficient for discharging the load 3 at an optimum angle. Furthermore, the longer carrying member 8 protrudes beyond the rear end of the vehicle 2 for greater than desired distance resulting in unbalanced load carrying condition.

Now in reference to FIG. 8, the positions of the cab 4 and the power plant 6 have been adjusted forward by way of the support members 70, 72. Consequently, the load carrying member 8 can also move in a forward direction reducing the protrusion of its rear end beyond the rear end of the suspension member 10 and, more importantly, increasing the pivoting angle a₂.

However, to achieve the optimum pivot angle a₃ of between about sixty (60) and about seventy (70) degrees of FIG. 9 and enable the load carrying member 8 to discharge the load 3, the elongated members 62 are adjusted toward the rear of the vehicle 2, extending the pivot joint assemblies 90 a predetermined distance beyond the rear end of the suspension members 10. Advantageously, rearward adjustment of the elongated members 62 provides for a balanced load carrying condition. It is further preferred to limit each of the forward protrusion of the cab 4 and the power plant 6 and rearward protrusion of the load carrying member 8 to about 3 feet in order to utilize suspension members 10 presently in use.

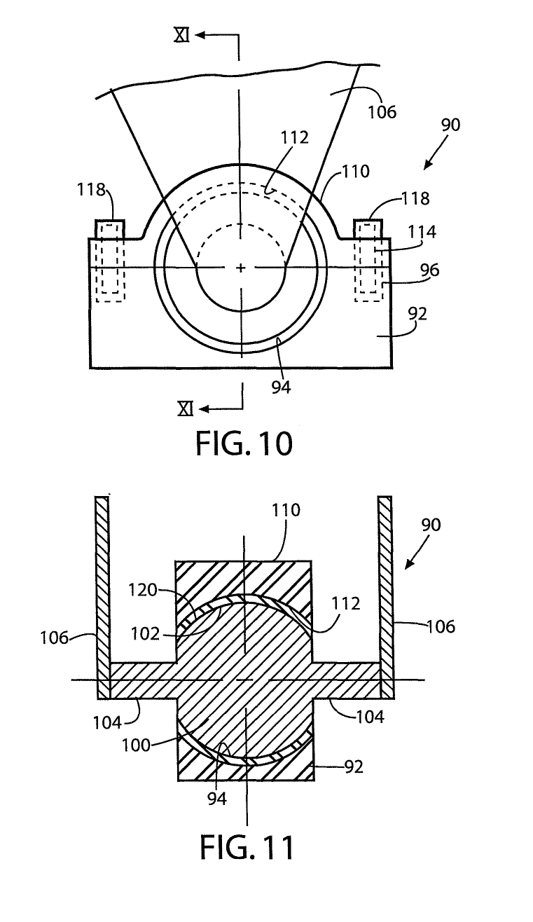

In accordance with yet another embodiment of the present invention therein provided a novel pivot assembly 90. Now in a particular reference to FIGS. 10-11, the pivot assembly 90 includes a first female connection member 92 which is secured to the undercarriage frame 20. When the vehicle 2 is provided with the above-described elongated members 62, each first female connection member 92 will be secured to a respective elongated member 62. The first female connection member 92 has a substantially spherical cavity 94. A male connection member 100 is also provided. The male connection member 100 has a substantially spherical portion 102 which is partially disposed within the spherical cavity 94. The male connection member 100 also has a pair of axially aligned and oppositely disposed ends 104. Each end 104 is rigidly attached to a bracket 106 which is affixed to the underside of the load carrying member 8. A second female connection member 110 is also provided and has a substantially spherical cavity 112 sized to operatively abut the outer surface of the spherical portion 102 of the male connection member 100. In use, the substantially spherical cavities 94 and 112 cage the substantially spherical portion 102 therebetween. The second female connection member 110 has a predetermined plurality of apertures 114 disposed at each end thereof and aligned with threaded bores 96 provided within the first female connection member 92. Thus, the second female connection member 110 is simply secured to the first female connection member 92 by way of threaded fasteners 118 to cage the substantially spherical portion 102 and enable rotation of the male connection member 100 and, more importantly, enable rotation of the load carrying member 8.

The substantially spherical inner surface formed by the surfaces of the substantially spherical cavities 94, 112 provides a surface which enables movement of the male connection member in relation to such female connection members 92, 110 in both a vertical direction and a horizontal direction over a predetermined range of angles measured from a centerline of the substantially spherical portion 102 disposed in a vertical direction and from a longitudinal axis of such pivot assembly 90 disposed in a horizontal direction.

If required to reduce friction forces during rotation movement of the spherical portion 102 within the spherical cavities 94 and 112, a liner 120 may be provided. The liner 120 has a substantially spherical shaped inner surface which is engageable with at least a portion of the outer surface of such substantially spherical portion 102 and a substantially spherical outer portion which is engageable with at least a portion of the substantially spherical cavities 94, 112. The liner 120 may be provided as a pair of liner portions fitting in the space provided between the outer surface of the spherical portion 102 and surface of each spherical cavity 94, 112, so as to form a substantially spherical inner surface upon which the spherical portion 102 rotates against. The liner 120 may be formed from any well known material which has sufficient strength to withstand the forces generated by the rotation of the spherical portion 102 thereagainst. For example, the liner 120 can be formed from a metal which is cast, ground, or molded substantially to size. Alternatively, the liner 120 can be formed from a polymeric and/or composite material. By way of one example only, such polymeric material may be a Teflon.RTM. which is known as a polyester and which is a registered trademarks of E.I. Dupont De Nemours.

Although the present invention has been shown in terms of the vehicle 2 employing a track-type suspension members 10, it will be apparent to those skilled in the art, that the present invention may be applied to other suspension types, for example such as a conventional ground engaging wheels.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a work vehicle having an operating cab, a power plant positioned adjacent to said operating cab, a pair of suspension members operable by said power plant and spaced apart in a lateral direction, an undercarriage frame poisoned between said pair of suspension members and a load carrying member supported by each of said undercarriage frame and said pair of suspension members, means provided on said frame for adjusting longitudinal position of at least one of said operating cab and said power plant.

2. The vehicle, according to claim 1, wherein said undercarriage frame includes a housing having a predetermined shape and having a longitudinal axis thereof aligned with a longitudinal axis of said vehicle, said housing positioned intermediate said pair of suspension members, whereby each of said pair of suspension members is operatively mounted to a respective side of said housing.

3. The vehicle, according to claim 2, wherein said longitudinal position adjusting means includes:
(a) a pair of vertical flanges each secured to a respective side of said housing and aligned parallel to said longitudinal axis thereof;
(b) a predetermined plurality of first apertures formed through each flange and spaced apart in a longitudinal direction;
(c) a pair of spaced apart elongated members, each of said pair of spaced apart elongated member disposed parallel to said longitudinal axis of said housing and abuttingly engaging a respective vertical flange for supporting each of said cab, power plant and load carrying member;
(d) a predetermined plurality of second apertures formed through said each elongated member adjacent to and spaced from a bottom edge thereof, said predetermined plurality of second apertures are spaced apart in said longitudinal direction and alignable with said predetermined plurality of first apertures; and
(e) a predetermined plurality of fasteners passed through pre-selected first apertures and pre-selected second apertures for adjustably affixing said each elongated member to said respective vertical flange in said longitudinal direction.

4. The vehicle, according to claim 3, wherein said each flange is formed integral with said respective side of said housing.

5. The vehicle, according to claim 3, wherein each of said plurality of first apertures and said plurality of second apertures is formed transversely to said longitudinal axis of said housing.

6. The vehicle, according to claim 3, wherein said frame further includes a pair of vertical support flanges, each of said pair of vertical support flanges secured to said housing parallel to and laterally spaced from said respective vertical flange and wherein at least a portion of said each elongated member disposed adjacent said bottom edge thereof is caged between said each vertical support flange and said respective vertical flange and wherein said fasteners further pass through apertures formed in said each vertical support member.

7. The vehicle, according to claim 2, wherein said longitudinal position adjusting means includes:
(a) a pair of spaced apart elongated members, each of said pair of spaced apart elongated member disposed parallel to said longitudinal axis of said housing and secured to a top surface thereof for supporting each of said operating cab, power plant and load carrying member;
(b) a predetermined plurality of first apertures formed through said each elongated member adjacent to a front end thereof, said predetermined plurality of first apertures are spaced apart in said longitudinal direction;
(c) at least one support member secured to at least one of said cab and said power plant;
(d) a predetermined plurality of second apertures formed through said at least one support member and spaced apart in said longitudinal direction, said predetermined, plurality of second apertures alignable with said predetermined plurality of first apertures; and
(e) a predetermined plurality of fasteners passed through pre-selected first apertures and pre-selected second apertures for adjustably affixing said cab and said power plant in said longitudinal direction relative to said housing.

8. The vehicle, according to claim 7, wherein said at least one support member is a pair of support members, one of said pair of support members is secured to a bottom surface of said operating cab and another one of said pair of support members carries at least a portion of said power plant thereon, wherein each of said pair of support members has a flange disposed in a vertical plane and positioned in abutting engagement with a respective elongated member, and wherein said predetermined plurality of second apertures is formed through each flange.

9. The vehicle, according to claim 1, wherein each suspension member includes an endless track, a track frame, a driving wheel attached to said track frame and operatively coupled to said power plant, an idler wheel attached to said track frame and an odd quantity of load support wheels mounted on a bottom portion of said track frame, wherein said support wheels are disposed in tandem and wherein a single wheel is mounted at rear end of said each suspension member for improving reaction forces thereof when said vehicle operates on a grade.

10. The vehicle, according to claim 1, wherein said undercarriage frame includes a swing mechanism and wherein said longitudinal position adjusting means is affixed thereon.

11. The vehicle, according to claim 1, wherein said undercarriage: frame includes means for adjusting lateral spacing between said pair of suspension members.

12. The vehicle, according to claim 1, wherein said undercarriage frame includes means for pivotal movement of said load carrying member.

13. In combination with a work vehicle having an operating cab, a power plant positioned adjacent to said operating cab, a pair of suspension members operable by said power plant and spaced apart in a lateral direction, and a load carrying member supported by said pair of suspension members, an adjustable undercarriage frame comprising:
(a) a housing having each of a predetermined shape and a longitudinal axis thereof aligned with said longitudinal axis of said vehicle, said housing positioned intermediate said pair of suspension members;
(b) a pair of spindle shafts positioned in said lateral direction and spaced apart along said longitudinal axis, each of said pair of spindle shafts secured to said housing adjacent a respective end thereof; and
(c) means engageable with said each spindle shaft for adjusting lateral spacing between said pair of suspension members.

14. The frame, according to claim 13, wherein said housing includes a first longitudinal side wall member, an opposed second longitudinal side wall member, a top member and a bottom member, forming in combination a hollow interior portion.

15. The frame, according to claim 14, wherein said housing further includes a first pair of spaced-apart apertures formed through said first side wall member and a second pair of spaced-apart apertures formed through said second side wall member in respective alignment with said first pair of apertures, and wherein said each spindle shaft is passed through a respective pair of apertures aligned in said lateral direction.

16. The frame, according to claim 13, wherein said lateral spacing adjusting means includes:
(a) a predetermined plurality of first apertures formed in a spaced relationship through each end of said each spindle shaft;
(b) a quartet of tubular sleeves, each of said quartet of tubular sleeves secured to a respective suspension member, said each sleeve having an inner surface thereof sized for slidable engagement with an outer surface of said each end of said each spindle shaft;
(c) a second aperture formed through said each sleeve and alignable with a selected one of said predetermined plurality of first apertures based on a pre-selected lateral spacing between said pair of suspension members; and
(d) a predetermined plurality of pins, each of said predetermined plurality of pins passed through said second aperture and said selected first aperture aligned therewith for fixing said lateral spacing of said pair of suspension members.

17. The frame, according to claim 13, wherein said frame further includes means for adjusting longitudinal position of at least one of said operating cab, power plant and load carrying member.

18. In a work vehicle having an undercarriage frame, an operating cab positioned on a front end of said undercarriage frame, a power plant positioned adjacent to said operating cab, a pair of suspension members operable by said power plant and spaced apart in a lateral direction, and a load carrying member supported on said undercarriage frame, an improvement comprising:
(a) at least one first female connection member secured to said undercarriage frame;
(b) a first substantially spherical cavity formed in said at least one first female connection member;
(c) at least one male connection member having a substantially spherical portion at least partially disposed within said first substantially spherical cavity and a pair of axially aligned and oppositely disposed ends, each of said pair of ends secured to said load carrying member;
(d) at least one second female connection member;
(e) a second substantially spherical cavity formed in said at least one second female connection member and wherein said substantially spherical portion of said male connection member is at least partially disposed within said second substantially spherical cavity; and
(f) means for affixing said at least one second female connection member to said at least one first female connection member and operatively caging said substantially spherical portion of said at least one male connection member between said first and second substantially spherical cavities.

19. The improvement, according to claim 18, wherein said improvement further includes a liner formed from a predetermined material and operatively disposed between an exterior surface of said substantially spherical portion and surfaces of said first and second substantially spherical cavities for reducing friction forces during rotation of said mail connection member.
